(19) United States
(12) Patent Application Publication
(10) Pub. No.: US 2025/0326422 A1
(43) Pub. Date: Oct. 23, 2025

(54) STROLLER TRAY

(71) Applicant: TWEELY INC., Spring Valley, NY (US)

(72) Inventors: Samuel Weber, Spring Valley, NY (US); Esther Weber, Spring Valley, NY (US)

(73) Assignee: TWEELY INC., Spring Valley, NY (US)

(21) Appl. No.: 19/255,394

(22) Filed: Jun. 30, 2025

Related U.S. Application Data
(63) Continuation of application No. 29/954,955, filed on Jul. 30, 2024.
(63) Continuation of application No. 29/954,888, filed on Jul. 30, 2024.
Application No. 29/954,888 is a continuation-in-part of application No. 29/878,221, filed on Jun. 19, 2023, now Pat. No. D1045695.

(51) Int. Cl. B62B 9/26

(52) U.S. Cl. CPC B62B 9/26

(57) ABSTRACT

A stroller tray includes a tray portion comprising at least one cup holder and at least one snack compartment and at least two bendable arms. The bendable arms are detachably connected to the tray portion by at least one mount on the outer end of the tray portion. The bendable arms attach to a stroller bumper bar by wrapping around the stroller bumper bar while the tray portion remains level with the stroller bumper bar. The bendable arms each contain an inner bendable rod. A method of providing a stroller tray includes providing a tray portion comprising at least one cup holder and at least one snack compartment; and providing at least two bendable arms. The method of providing a stroller tray further includes providing at least one mount on the outer end of the tray portion to detachably connect the bendable arms to the tray portion.

### CROSS REFERENCE TO RELATED APPLICATIONS

This application is a continuation application claiming priority under 35 U.S.C. § 120 to U.S. Design patent application Ser. No. 29/954,955, entitled STROLLER TRAY, filed Jul. 30, 2024 and to U.S. Design patent application Ser. No. 29/954,888, entitled STROLLER TRAY, filed Jul. 30, 2024, both of which claim priority under 35 U.S.C. § 120 to U.S. Design patent application Ser. No. 29/878,221, now U.S. Pat. No. D1,045,695, entitled STROLLER TRAY, filed Jun. 19, 2023, the entire content of which is hereby incorporated by reference herein.

### BACKGROUND

This disclosure relates to components and accessories for baby and children's strollers, specifically stroller trays.

Stroller trays are a convenience for caregivers and children alike. They allow babies or children access to food, drinks, and toys while on-the-go, without requiring that the caregivers or children hold the items continuously or store them where the caregivers must reach for and hand the children each item every time the children desire it.

However, all stroller trays are not the same. If a stroller tray does not have a secure design, there is a risk of its connection to the stroller failing and the tray as well as any items on the tray may fall off. On the other hand, if a stroller tray design causes the tray to be secured too tightly, caregivers may have difficulty removing the stroller tray for cleaning purposes.

A stroller tray must also be accessible to caregivers to place items on the tray and to children sitting in the stroller to reach the items. Stroller trays should also have snack compartments that are deep enough to ensure that snacks remain inside the compartments even on rough terrain.

Additionally, certain trays are manufactured in configurations that are compatible with only certain brands of strollers or strollers with bars in specific shapes and sizes. Such configuration limits the number of strollers to which a stroller tray can be attached.

Stroller trays should also be designed to be able to remain attached to the stroller when the stroller is folded and not require removal.

Further, the height of the stroller tray is important, as children must be able to see and reach their snacks on the tray when they are sitting in the stroller.

### SUMMARY

One object of the present invention is to provide a stroller tray that securely attaches to a stroller.

Another object of the present invention is to provide a stroller tray that is easily accessible to caregivers and to children sitting in the stroller.

Another object of the present invention is to provide a stroller tray that is compatible with numerous types of strollers.

Another object of the present invention is to provide a stroller tray that attaches to a stroller at a height where children are able to see and reach their snacks on the tray when they are sitting in the stroller.

Another object of the present invention is to provide a stroller tray with an adjustable height when secured to a stroller.

Some embodiments of the present invention are directed to a stroller tray including a tray portion comprising at least one cup holder and at least one snack compartment and at least two bendable arms.

In some embodiments of the present invention, the at least two bendable arms are tubular in shape when not bent and are detachably connected to said tray portion by at least one mount on the outer end of the tray portion.

In some embodiments of the present invention, at least two bendable arms attach to a stroller bumper bar by wrapping around the stroller bumper bar and gripping the stroller bumper bar while the tray portion remains level with the stroller bumper bar.

In some embodiments of the present invention, at least one cup holder is circular in shape and has a contoured surface.

In some embodiments of the present invention, at least one cup holder is sized to hold standard-size bottles and children's sippy cups.

In some embodiments of the present invention, at least one cup holder is sized to accommodate any size drink container, including large bottles and cups.

In some embodiments of the present invention, at least one snack compartment has a contoured surface that is larger in width than at least one cup holder but smaller in depth than at least one cup holder.

In some embodiments of the present invention, at least one snack compartment is generally oval in shape, with a wall of at least one snack compartment adjoining at least one cup holder being curved to wrap around the circular edge of at least one cup holder.

In some embodiments of the present invention, the tray portion is curved in a U-shape to align with the shape of a curved stroller bumper bar.

In some embodiments of the present invention, at least two bendable arms are coated in gripping materials.

In some embodiments of the present invention, at least two bendable arms are coated in silicone.

In some embodiments of the present invention, at least two bendable arms each contain an inner bendable rod.

In some embodiments of the present invention, the inner bendable rod is made of metal material.

In some embodiments of the present invention, the tray portion can be easily detached from said at least two bendable arms.

In some embodiments of the present invention, the tray portion is dishwasher safe.

Some embodiments of the present invention are directed to a method of providing a stroller tray including providing a tray portion comprising at least one cup holder and at least one snack compartment; and providing at least two bendable arms.

In some embodiments of the present invention, the method of providing a stroller tray further including providing at least two bendable arms in a tubular shape when not bent; providing at least one mount on the outer end of the tray portion to detachably connect at least two bendable arms to the tray portion; and providing at least one mount in a location wherein at least two bendable arms attach to a stroller bumper bar while the tray portion remains level with the stroller bumper bar.

In some embodiments of the present invention, the method of providing a stroller tray further including providing at least one cup holder that is circular in shape and has a contoured surface; providing at least one cup holder that is sized to hold standard-size bottles and children's sippy cups; providing at least one snack compartment that has a contoured surface that is larger in width than at least one cup holder but smaller in depth than at least one cup holder; providing at least one snack compartment that is generally oval in shape, with a wall of at least one snack compartment adjoining at least one cup holder being curved to wrap around the circular edge of at least one cup holder.

In some embodiments of the present invention, the method of providing a stroller tray further including providing at least two bendable arms that are coated in gripping materials; and providing at least two bendable arms that each contain an inner bendable rod.

The above and other features, elements, characteristics, steps, and advantages of the present invention will become more apparent from the following detailed description of preferred embodiments of the present invention with reference to the attached drawings.

### BRIEF DESCRIPTION OF THE DRAWINGS

FIG. 1 is a perspective view of the stroller tray in accordance with one embodiment of the present invention.

FIG. 2 is a front view of the stroller tray in accordance with one embodiment of the present invention.

FIG. 3 is a rear view of the stroller tray in accordance with one embodiment of the present invention.

FIG. 4 is a left view of the stroller tray in accordance with one embodiment of the present invention.

FIG. 5 is a right view of the stroller tray in accordance with one embodiment of the present invention.

FIG. 6 is a top view of the stroller tray in accordance with one embodiment of the present invention.

FIG. 7 is a bottom view of the stroller tray in accordance with one embodiment of the present invention.

FIG. 8 is a perspective view of the stroller tray with coiled arms in accordance with one embodiment of the present invention.

### DETAILED DESCRIPTION OF PREFERRED EMBODIMENTS

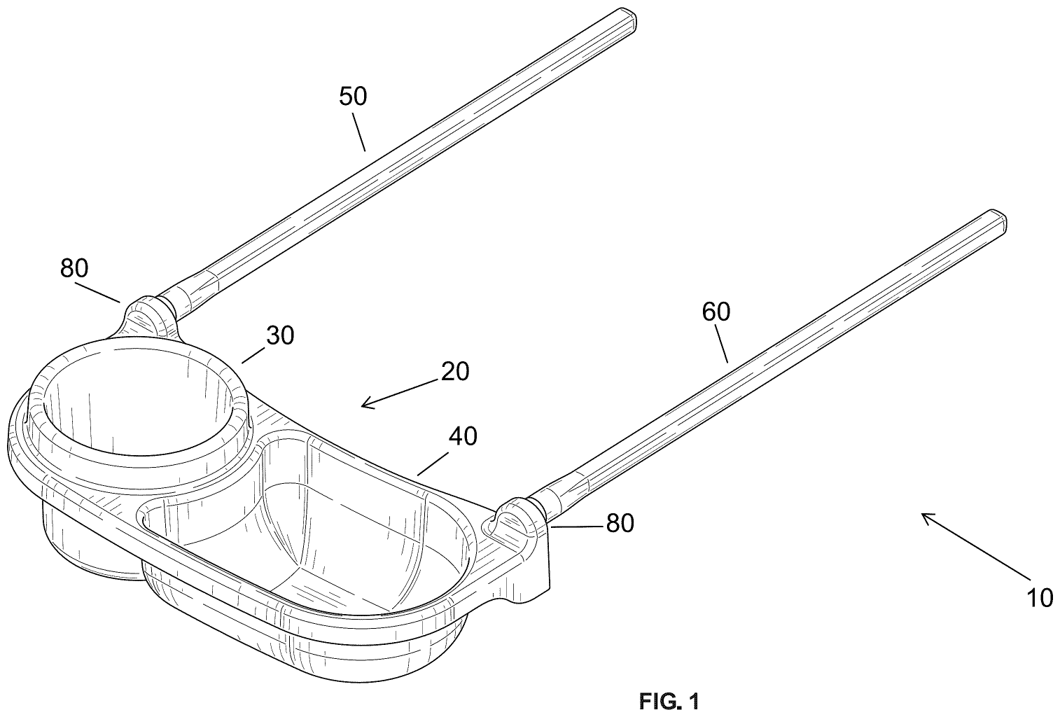

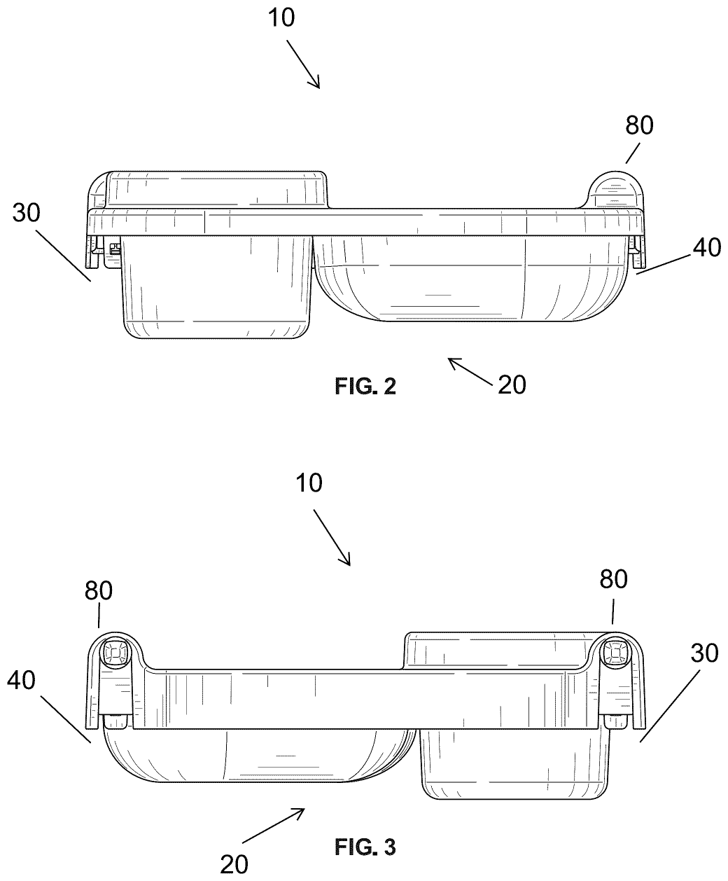

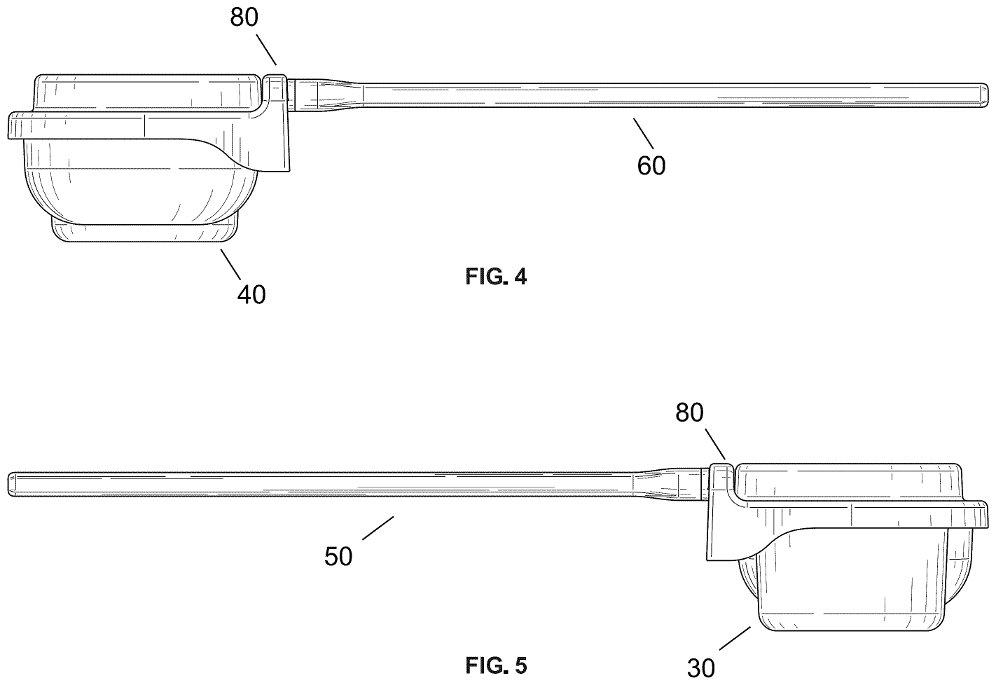

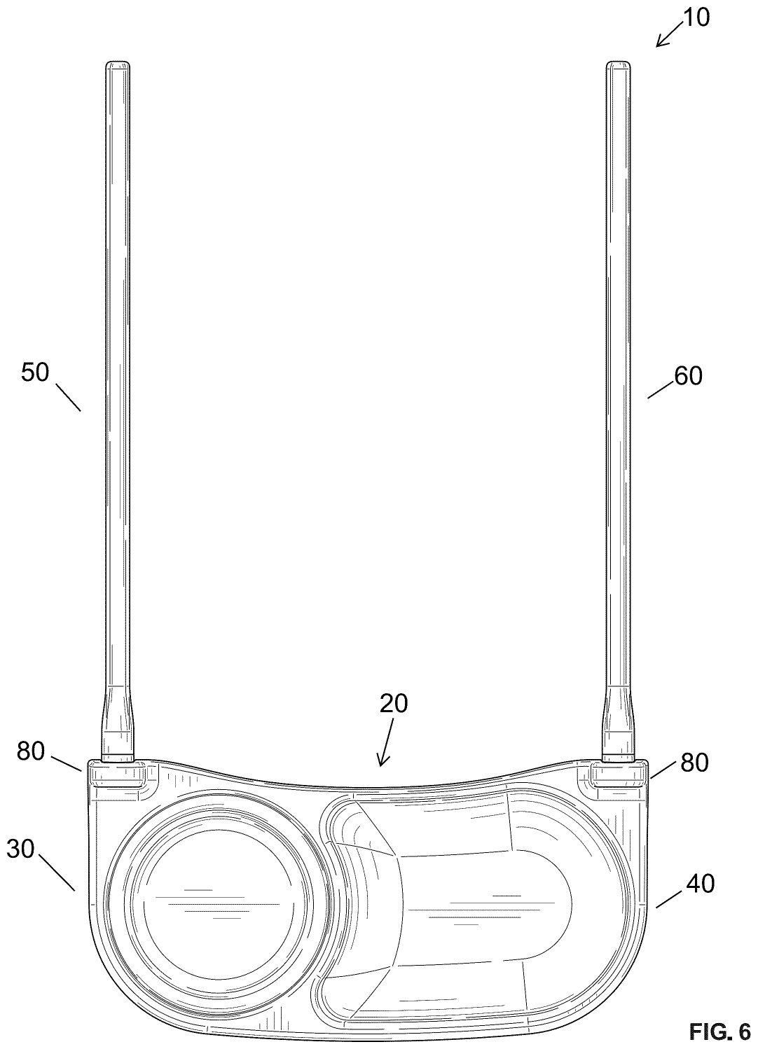

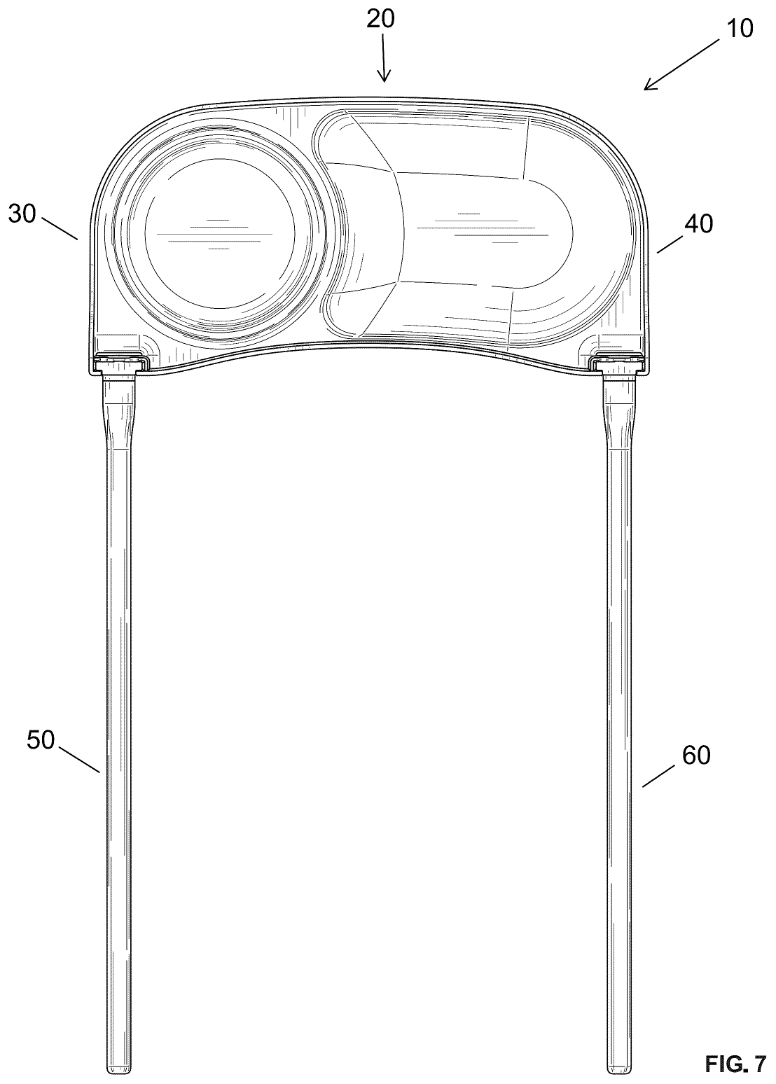

FIGS. 1-7 illustrate embodiments of the disclosed invention. Stroller tray 10 includes a tray portion 20 containing at least one cup holder 30 and at least one snack compartment 40. Stroller tray 10 may also contain at least two bendable arms 50, 60.

In some embodiments, cup holder 30 is circular in shape and has a contoured surface for cradling a cup. Cup holder 30 may be sized to hold standard-size bottles and children's sippy cups in a secure fashion. Alternatively, cup holder 30 may be sized to accommodate any size drink container, including large bottles and cups.

In some embodiments, snack compartment 40 has a contoured surface that may be larger in width than cup holder 30 but may be smaller in depth than cup holder 30. Snack compartment 40 may be generally oval in shape, with the wall of snack compartment 40 that adjoins cup holder 30 being curved to wrap around the circular edge of cup holder 30.

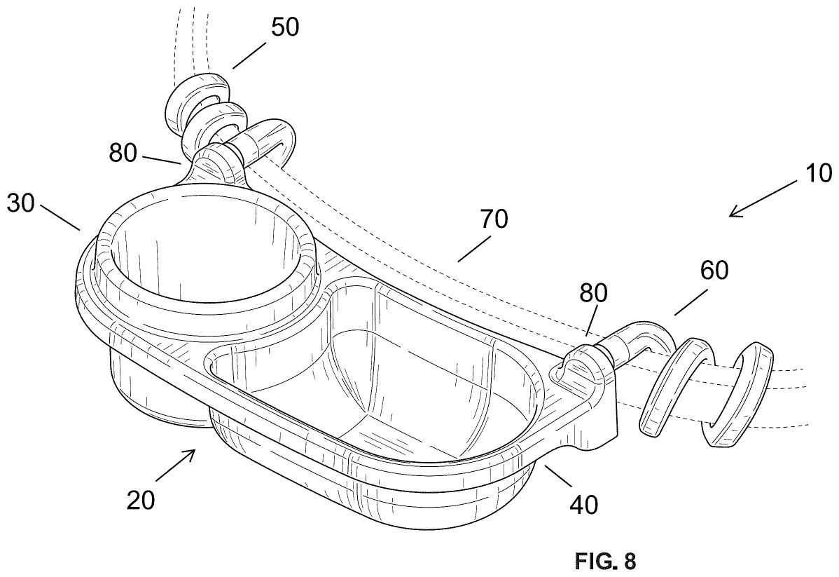

As shown in FIG. 8, tray portion 20 may be curved in a U-shape to align with the shape of curved stroller bumper bar 70 for a seamless fit with strollers.

As shown in FIGS. 1-8, bendable arms 50, 60 may be tubular in shape when not bent and may be detachably connected to tray portion 20 by at least one mounts 80 on the outer end of tray portion 20. At least one mount 80 may be raised above tray portion 20. At least one mount 80 may be directly formed from the outer end of tray portion 20. Bendable arms 50, 60 may attach to stroller bumper bar 70 by wrapping around stroller bumper bar 70 and gripping stroller bumper bar 70 securely. At least one mount 80 ensures that tray portion 20 remains level with stroller bumper bar 70, thereby facilitating easy access to tray portion 20 for children sitting in a stroller.

Bendable arms 50, 60 may be coated in silicone or other similar gripping materials and may each contain an inner metal bendable rod, which prevents bendable arms 50, 60 from uncoiling too easily.

Stroller tray 10 is designed to remain attached to stroller bumper bar 70 when a stroller is folded and does not require removal for folding of a stroller.

In some embodiments, tray portion 20 can be easily detached from bendable arms 50, 60 and is dishwasher safe.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A stroller tray comprising:
a tray portion comprising at least one cup holder and at least one snack compartment; and
at least two bendable arms.

2. The stroller tray of claim 1, wherein said at least two bendable arms are tubular in shape when not bent.

3. The stroller tray of claim 1, wherein said at least two bendable arms are detachably connected to said tray portion by at least one mount on the outer end of said tray portion.

4. The stroller tray of claim 1, wherein said at least two bendable arms attach to a stroller bumper bar by wrapping around said stroller bumper bar while said tray portion remains level with said stroller bumper bar.

5. The stroller tray of claim 1, wherein said at least one cup holder is circular in shape and has a contoured surface.

6. The stroller tray of claim 1, wherein said at least one cup holder is sized to hold standard-size bottles and children's sippy cups.

7. The stroller tray of claim 1, wherein said at least one cup holder is sized to accommodate any size drink container, including large bottles and cups.

8. The stroller tray of claim 1, wherein said at least one snack compartment has a contoured surface that is larger in width than said at least one cup holder but smaller in depth than said at least one cup holder.

9. The stroller tray of claim 5, wherein said at least one snack compartment is generally oval in shape, with a wall of said at least one snack compartment adjoining said at least one cup holder being curved to wrap around the circular edge of said at least one cup holder.

10. The stroller tray of claim 1, wherein said tray portion is curved in a U-shape to align with the shape of a curved stroller bumper bar.

11. The stroller tray of claim 1, wherein said at least two bendable arms are coated in gripping materials.

12. The stroller tray of claim 3, wherein said at least one mount is directly formed from an outer end of said tray portion.

13. The stroller tray of claim 1, wherein said at least two bendable arms each contain an inner bendable rod.

14. The stroller tray of claim 13, wherein said inner bendable rod is made of metal material.

15. The stroller tray of claim 1, wherein said tray portion is dishwasher safe.

16. A method of providing a stroller tray comprising:
providing a tray portion comprising at least one cup holder and at least one snack compartment; and
providing at least two bendable arms.

17. The method of claim 16, further comprising:
providing said at least two bendable arms in a tubular shape when not bent;
providing at least one mount on the outer end of said tray portion to detachably connect said at least two bendable arms to said tray portion; and
providing said at least one mount in a location wherein said at least two bendable arms attach to a stroller bumper bar while said tray portion remains level with said stroller bumper bar.

18. The method of claim 16, further comprising:
providing said at least one cup holder that is circular in shape and has a contoured surface;
providing said at least one cup holder that is sized to hold standard-size bottles and children's sippy cups;
providing said at least one snack compartment that has a contoured surface that is larger in width than said at least one cup holder but smaller in depth than said at least one cup holder;
providing said at least one snack compartment that is generally oval in shape, with a wall of said at least one snack compartment adjoining said at least one cup holder being curved to wrap around the circular edge of said at least one cup holder.

19. The method of claim 16, further comprising:
providing said at least two bendable arms that are coated in gripping materials;
providing said at least two bendable arms that each contain an inner bendable rod.

20. The method of claim 16, further comprising:
providing said tray portion that is curved in a U-shape to align with the shape of a curved stroller bumper bar.
